(19) United States
(12) Patent Application Publication
(10) Pub. No.: US 2004/0257456 A1
(43) Pub. Date: Dec. 23, 2004

(54) Digital camera having nonvolatile memory for storing intermediate data associated with image processing

(76) Inventors: Andrew C. Goris, Loveland, CO (US); Mark J. Bianchi, Fort Collins, CO (US); Robert E. Sobol, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/462,967

(22) Filed: Jun. 17, 2003

(51) Int. Cl. H04N 5/335

(52) U.S. Cl. 348/231.99

(57) ABSTRACT

A digital camera has a removable nonvolatile memory for storing compressed images. The camera is capable of performing advanced image processing, and has a second nonremovable nonvolatile memory for storing intermediate results of advanced processing. The intermediate results are saved upon the nonremovable, nonvolatile, memory periodically, upon detection of low battery, or both. If batteries are replaced or external power is connected, under some conditions the camera's image processing subsystem can restart advanced processing. When advanced processing is restarted, these saved intermediate results are used to save processing time by avoiding the need to repeat some previously performed portions of advanced processing. In an alternative embodiment, the camera is capable of storing intermediate results upon the removable nonvolatile memory also used for storing compressed images.

### RELATED APPLICATIONS

This application is related to copending and cofiled applications for United States patent application entitled “Digital Camera And Method For Slowing, Delay And/Or Suspending Advanced Processing During Low Battery Conditions To Conserve Battery Charge”, Attorney Docket No. 200308582-1 and United States patent application entitled “User Interface For Digital Camera Having Nonvolatile Memory For Storing Intermediate Data For Advanced Processing And Capable Of Slowing, Delaying And/Or Suspending Advanced Processing During Low Battery Conditions”, Attorney Docket No. 200308583-1 all of the aforementioned applications are incorporated herewith by reference thereto.

### FIELD OF THE APPLICATION

The present application relates to the field of digital cameras. In particular, the application relates to apparatus and methods for minimizing power consumption and battery drain during advanced processing of images on digital cameras.

### BACKGROUND

Modern digital cameras generally have a lens system and image sensor for capturing an image. Once captured, the image is digitized and transferred to an embedded image-processing computer system within the camera for processing. Digital cameras typically perform several stages of image processing; an initial preprocessing stage typically includes correction of defective pixels and color processing. Color processing typically includes derivation of three color planes from raw image sensor data. For purposes of this document, a raw image includes digitized image sensor data, sensor data corrected for defective pixels, or an image subjected to color processing. A compression stage of image processing typically performs image compression. As or after processing occurs, the embedded image-processing computer system saves the processed image in a nonvolatile memory for storage and transport.

In addition to the processor in the image-processing computer system, there may be additional embedded processors in the camera, such as a management processor responsible for power management, trigger and configuration button polling, flash memory control, battery maintenance and charge monitoring, and other functions.

Typical nonvolatile memories include ‘Flash’ EEPROM memories. Low power nonvolatile memory technologies, including ferroelectric memory devices and battery-backed-up CMOS RAM devices, also are available on the market. For purposes of this document, the term ‘nonvolatile memory’ includes nonvolatile memory of EEPROM, ferroelectric, battery-backup CMOS memory, and other memory devices capable of retaining data for a significant time with primary system power removed. Many digital cameras available on the market are equipped with removable nonvolatile memory for storage of compressed images. This removable nonvolatile memory may be in modules such as Memory Stick, Compact Flash, Smartmedia, and other forms.

U.S. Pat. No. 6,052,692 (the '692 patent) describes a camera capable of storing still images on removable nonvolatile media in two forms with different filename suffixes. The camera of '692 saves its images on the media initially in an uncompressed file, then when compression is completed; it saves its images again in a compressed file. Once the image is saved in compressed form, the camera of '692 deletes the uncompressed file. Should the removable nonvolatile media be removed from, and reinserted into, the camera of '692, the camera can restart compressing images found in uncompressed files on the removable nonvolatile media.

Typically, image processing performed by the embedded image-processing system includes autofocus operations performed before image capture. After image capture, the embedded image-processing system performs color processing and image compression. Image compression by digital cameras of still images is often performed according to Joint Picture Experts Group (JPEG) standards. Other compression standards and file format standards may be used, including Graphics Interchange Format (GIF), Tagged-Image-File-Format (TIFF) and Lempel-Ziv-Welch (LZW)-TIFF. Many digital cameras are also capable of capturing a sequence of images as a video and compressing them according to Motion Picture Experts Group (MPEG) video-compression standards. Again, other video compression standards may be used by some cameras including Audio-Video-Interleaved (AVI) formats.

The JPEG standard offers several compression options, some of which require less intensive computation than others, and some, such as wavelet compression, that offer better compression at cost of significantly greater computation.

It is known that additional image processing may be performed by the embedded image-processing systems of digital cameras, including blur correction, edge enhancement, contrast and brightness adjustment or enhancement, and color correction and enhancement. All image processing takes time, even with modern, high-speed, embedded image-processing systems. Advanced local contrast enhancement, blur correction and edge enhancement algorithms can take several seconds to minutes per image. All image processing requires significant power consumption by the embedded image-processing system of the camera; advanced image processing can represent a substantial drain on a camera's battery.

For example, a method of blur correction for still images requires capture of several raw images at a high frame rate. A high frame rate is used to minimize blur in each raw image. However, at high frame rates, each raw image may be significantly underexposed, such that the image's color may be degraded and its noise may be increased. Edge detection can be performed on each raw image. Corresponding regions in the raw frames can be determined, and a warping function established. The corresponding regions are then aligned and averaged, such that a corrected image is created having color and picture noise qualities of a long exposure, with blur of a short exposure. The corrected image then must be compressed for storage.

With a blur correction algorithm, intermediate edge-detected images, warp functions, warped temporary images, potentially even parts of the corrected image, are large intermediate products that must be stored, typically in RAM, during processing. Further, the edge detection, warping, and image averaging processes required for blur correction can take significant processing time.

The MPEG video-compression standard provides for several levels of compression, where higher compression generally requires greater processing time for similar image quality. Video is typically captured as a sequence of frames, where each frame is—before compression—a separate still image. In MPEG parlance, an I-frame (or initial frame) is a full image that has been captured and compressed in a manner similar to compression of JPEG still images. Many digital cameras available today are capable of capturing an MPEG video as a sequence of I-frames. A P-frame, (or predicted frame) of an MPEG video is compressed by determining differences between the current frame and a prior frame—typically an I-frame—of the video, these differences are then coded and transmitted. A video file compressed as a sequence of I and P frames is typically significantly smaller than a video compressed as a sequence of I-frames of similar quality. Compression of a video as a sequence of I- and P-frames does, however, requires significantly more image processing than compression of a sequence of I-frames alone.

Other video compression standards exist, and may use different terminology for full image frames and derived image frames. For purposes of this document, an I-frame is any frame of a video that is not derived in part from other frames of a video. A P-frame is any frame that is compressed based upon any other frame or frames of the video. For purposes of this document, a sequence of I- and P-frames includes an MPEG video compressed as a sequence of I-, P-, and B-frames.

Advanced processing may include automatic generation of photomosaics by recognizing similar portions of successive images, adjusting exposure, and stitching the images together to form a larger image. Automatic photomosaic generation can be useful in generating high resolution panoramic images.

Advanced processing may also include blending of images having different exposure characteristics, such as an over-exposed and an under-exposed image, into single images having greater dynamic range than ordinarily available with the image sensor and analog-to-digital converter of the camera.

For purposes of this document, image processing performed after initial capture, color processing, and compression of an image is known as advanced image processing. Advanced image processing may include recompression of an image or video into a more highly compressed or more portable form, blur correction, local contrast enhancement, automatic photomosaic creation, exposure blending, or other image enhancement.

Many modern digital cameras have image sensors capable of capturing four million, or more, pixels per image; market forces are leading to an increase in pixel count of digital camera image sensors because image quality can improve as pixel count increases. The larger the pixel count, the more time and battery charge are consumed during image processing and storage of captured images.

Digital cameras are typically designed as portable, lightweight, battery-operated devices. Market forces place a premium on physically small cameras; small cameras require correspondingly small batteries.

Battery capacity often limits the utility of digital cameras, since once battery charge is exhausted no further images can be captured. It is desirable to conserve battery charge such that a camera user is not prevented from capturing images because of dead batteries.

It is known that battery capacity, as measured in ampere-hours, under high-load conditions is very dependent on the load. If a battery is capable of maintaining a current of A for time T, it may be able to maintain a current of 2A for significantly less than ½T. This phenomenon is partly a consequence of the effective internal resistance of the battery, where under high load some battery energy dissipates as heat in the battery instead of in the load. Battery discharge versus time curves vary significantly with battery chemistry and size.

Battery charge-level monitoring circuitry for a variety of battery chemistries is known in the art. Battery charge-level monitoring circuitry typically uses a combination of timers, load current monitoring, and battery voltage measurements to determine an approximate percentage of remaining battery charge.

Many cameras store images to removable nonvolatile memory. Should the nonvolatile memory be removed while the camera is writing to the nonvolatile memory, saved images may be incomplete or corrupt.

### SUMMARY

A digital camera has a removable nonvolatile memory for storing compressed images. The camera is capable of performing advanced image processing, and has a second nonremovable nonvolatile memory for storing partially-processed and/or intermediate results of advanced processing.

The partially-processed and/or intermediate results are saved on the nonremovable, nonvolatile, memory periodically, upon detection of low battery, or both. If batteries are replaced or external power is connected, under some conditions the camera's image processing subsystem can restart advanced processing. When advanced processing is restarted, these saved intermediate results are used to save processing time by avoiding the need to repeat some or all previously performed portions of advanced processing.

In an alternative embodiment, the camera is capable of storing intermediate results on the removable nonvolatile memory also used for storing compressed images.

### BRIEF DESCRIPTION OF THE FIGURES

FIG. 1 is a block diagram of a digital camera.

FIG. 1A is detail of buttons 118 of FIG. 1.

FIG. 2 is an example flowchart of a method for conserving battery charge in a digital camera.

FIG. 3 is an example flowchart of actions taken by the digital camera upon connection of external power or battery replacement.

FIG. 4 is an example flowchart of a portion of image processing illustrating how advanced processing may be conditioned upon user approval of an image.

FIG. 5 is an example flowchart illustrating how the battery reserve level may be selected and set by a user.

FIG. 6 is an example abbreviated flowchart illustrating how advanced processing is enabled and particular advanced processing features selected.

FIG. 7 is an example abbreviated flowchart illustrating operation of the processing status LED.

FIG. 8 is an example abbreviated flowchart illustrating operation of the menu system for displaying a list of images for which advanced processing is pending, and for reprioritizing images within this list.

FIG. 9 is an example of a menu screen allowing a user to select a reserve level for advanced processing

FIG. 10 is an example of a menu screen allowing a user to select reduced clock rates for advanced processing.

FIG. 11 is an example of a menu screen allowing a user to enable or disable advanced processing of images.

FIG. 12 is an example of a menu screen allowing a user to select a type of advanced processing to be performed on images.

FIG. 13 is an example of a menu screen allowing a user to select an image, and to check status of advanced processing of images.

FIG. 14 is an example of a menu screen allowing a user to delete, or cancel or prioritize advanced processing of, an image for which advanced processing is pending.

FIG. 15 is an example of a menu screen allowing a user to delete, or request advanced processing of, an image for which advanced processing has not previously been requested.

### DETAILED DESCRIPTION OF THE EMBODIMENTS

A digital camera 100 has a lens and image sensor 102 assembly for capturing an image. Captured images are transferred into an image processing system 104 for compression and color processing. Image processing system 104 uses RAM memory 106 for temporary storage, including temporary storage of intermediate and partially processed images. The image processing system contains firmware for performing initial compression, color processing, and advanced processing on images; in a particular embodiment the firmware includes routines for processing both high resolution still and lower resolution moving images. The image processing system 104 has firmware for saving, and saves, compressed images in a removable nonvolatile memory 108; and has firmware for transferring images to a display 109. Image processing system 104 operation is driven by an adjustable clock circuit 105.

Firmware is machine readable code for instructing a processor to perform a function. Firmware is typically located in a read-only or nonvolatile memory, while software is typically located in a random-access memory. Firmware may be located in a memory on a processor integrated circuit or on a separate integrated circuit coupled to the processor integrated circuit.

The camera 100 also has a management processor 110. The management processor 110 receives battery status and voltage information from a battery 112. Battery 112 is equipped with a battery charge-remaining monitor 113; the charge-remaining monitor 113 may have portions built into the battery and may have portions that are a nonremovable part of the camera. Timer functions of the charge-remaining monitor 113 may be implemented in management processor 110. Management processor 110 also controls a host interface 114 for transferring images to a host computer, has a nonvolatile memory 116 for storing camera configuration information, and monitors camera buttons 118. Management processor 110 also controls power to the image processing system 104.

In an embodiment of the present camera, an internal nonvolatile memory 120 is provided for storing intermediate data and partially processed images and videos under conditions of low battery 112 reserves. Nonvolatile memory 120 is also used for storing intermediate data and partially processed images when advanced processing is to be suspended for other reasons, such as new image capture.

Camera 100 also has an external power connector 124 for connection of an external AC power adapter (not shown), and a battery charger circuit 126 for charging the battery 112.

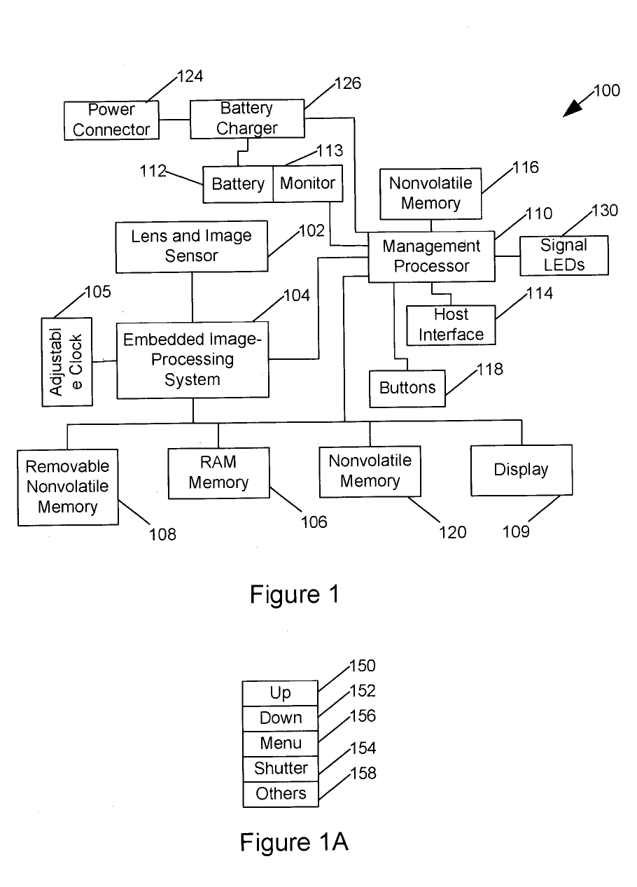

FIG. 1A is a detail of buttons 118 of FIG. 1, illustrating an ‘Up’ button 150, ‘Down’ button 152, ‘shutter’ button 154, and ‘menu’ button 156. There may also be one or more additional buttons 158.

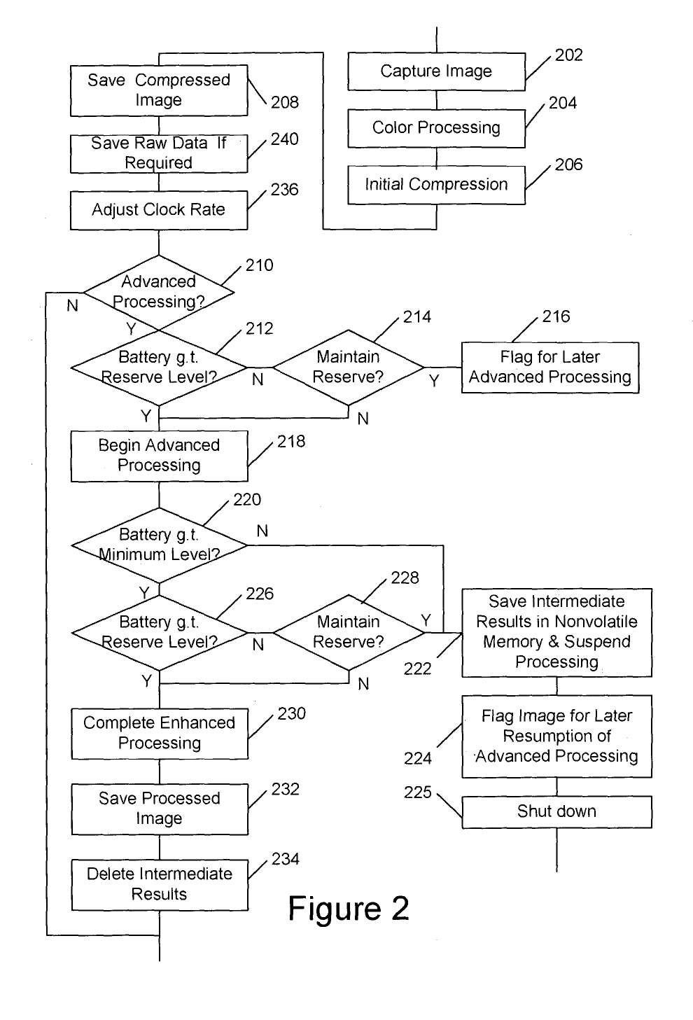

FIG. 2 is a flowchart illustrating exemplary actions performed by the camera 100 when a user triggers an image capture. After the lens and image sensor 102 capture 202 an image, it is transferred to the embedded image processing system 104 for color processing 204. Color processing 204 determines a color value for each pixel using nearby pixel readings, because most image sensors 102 do not have separate red, green, and blue sensing elements at each pixel location.

After color processing 204, initial image compression 206 is performed, and the image is saved 208 on removable nonvolatile memory 108. The embedded image processing system 104 may use RAM memory 106 while performing color processing 204, initial compression 206, or other image processing operations.

A flag in nonvolatile memory 116 of management processor 110 is checked to determine if 210 advanced image processing is enabled. If 210 advanced processing is enabled, battery charge is checked to determine if 212 charge is greater than a reserve charge level indicated by a location in nonvolatile memory 116 of management processor 110. If 212 battery charge is less than the reserve charge level, a flag is checked 214 in nonvolatile memory 116 of the management processor 110 to determine if the user wishes to maintain a battery reserve. This battery reserve charge location and flag is used to reserve battery charge for capturing additional images while battery charge is low. In another embodiment, the reserve level is set to the minimum level when no battery reserve is required; in this embodiment it is not necessary to have a reserve flag.

The minimum level is determined as the minimum battery charge level where the camera can capture, initially compress, and reliably write an entire image to nonvolatile memory. Once battery charge drops below the minimum level, the camera can not ‘take’ more pictures until batteries are recharged, replaced, or external power connected.

The reserve level is chosen to allow the user to capture, perform initial compression on, and save several additional images before battery charge drops below the minimum level.

If 210 advanced processing were enabled, but battery charge is low 212, a flag is set 216 marking the initial compressed image for later advanced processing in removable nonvolatile memory 108.

If 212 the battery charge is above the reserve level, or if 214 no reserve charge is desired, advanced image processing is begun 218. Periodically during advanced processing, battery status is checked again to determine if 220 charge remains above a minimum charge level. This minimum charge level is selected to enable the camera to save images, including saving 222 intermediate results, flag 224 the image as requiring a resumption of advanced processing, and shut down 225 when the battery charge is exhausted. Also periodically during advanced processing, battery status is checked to determine if 226 it remains above the reserve charge level, and the flag is checked to determine if 228 the user desires that a reserve charge be maintained. If charge falls below the reserve level, and a reserve is desired, intermediate results are saved 222, and the image is flagged 224 as requiring resumed advanced processing, and the image processing system shuts down 225 to conserve power.

Intermediate results, such as intermediate and partially processed images, are saved 222 with image identifying information that enables locating any associated initially saved image on removable nonvolatile memory 108. The term ‘intermediate results’ as used herein shall mean information that, if saved after advanced processing begins, may permit advanced processing to be restarted such that at least some stages of advanced processing, such as those completed prior to saving the intermediate results, need not be repeated upon restarting advanced processing. Information within intermediate results is expected to depend upon the particular advanced processing algorithm being executed, and the stage of advanced processing at which the intermediate results were saved. In an embodiment, intermediate results include partially processed images. In another embodiment, intermediate results include an image of portions of RAM memory 106.

After completing advanced processing 230, the camera 100 saves 232 the processed image to the removable nonvolatile memory 108, and deletes 234 the initial compressed image, any associated intermediate images and temporary data from the internal nonvolatile memory 120.

In a particular embodiment, after the initially compressed 206 image is stored 208, but before advanced processing begins 218, the adjustable clock circuit 105 is adjusted 236 from a fast clock used for initial compression 206 to a slow clock used for advanced processing 218, 230. Since current drawn from the battery 112 is less at slower clock rates and because many batteries provide more total energy at low current draw than at high current draw, use of a slow clock rate extends battery charge life. In an alternative embodiment, the adjustable clock circuit 105 is adjusted 236 to an advanced processing clock value set by a user and stored in nonvolatile memory 116 of management processor 110.

In another embodiment, the adjustable clock circuit 105 is adjusted to the value set by a user for advanced processing 218, 230 only if the camera is operating on battery power. In this embodiment, should power connector 124 be connected to an external power source, the battery charger 126 charges battery 112 and the adjustable clock circuit 105 is set to the fast clock for advanced processing 218, 230.

In an embodiment, advanced processing 218, 230, is selected according to an advanced processing type register in nonvolatile memory 116. Among the available options for advanced processing are:

Recompression of the image with a more space-efficient but computationally intensive algorithm than that used for initial compression 206,

Recompression into an alternative format,

Local contrast enhancement,

Blur correction as described in the background section of this document, automatic photomosaic creation, and

blending over and under exposed images to create an image having extended dynamic range.

It is expected that in alternative embodiments there may be additional types of advanced processing available.

In another embodiment, advanced processing 218, 230 includes reading a video previously saved as I-frames on the removable nonvolatile memory 108, recompressing the video with an algorithm using I-, P- and possibly B-frames, and writing the recompressed video to nonvolatile memory 108.

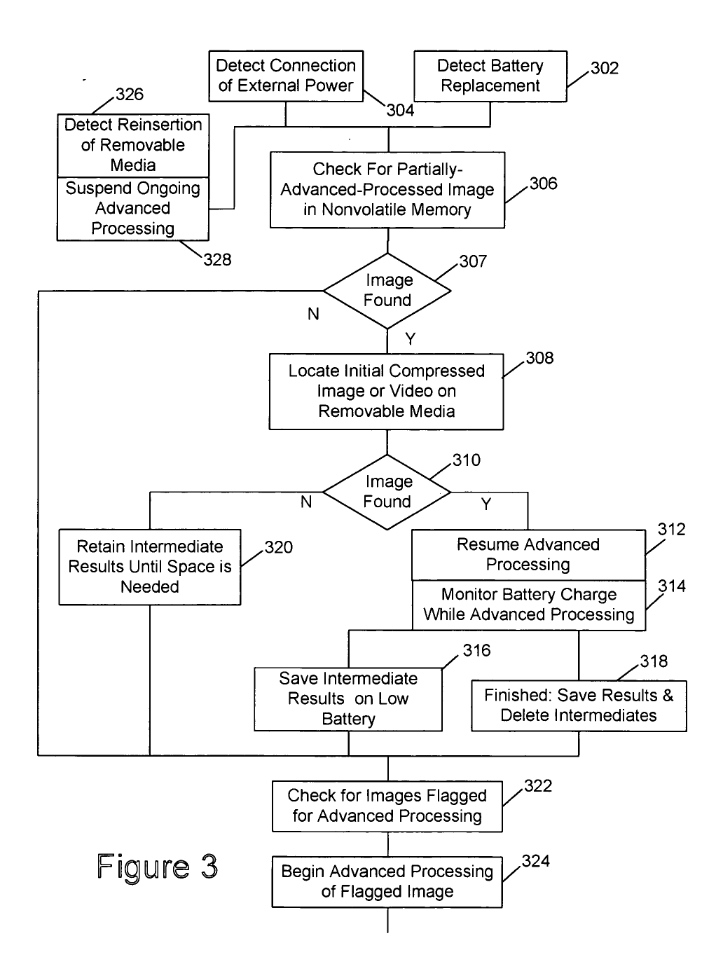

When the camera detects 302 that its battery 112 is replaced or detects 304 that external power is connected to external power connector 124, the camera executes firmware including the steps illustrated in FIG. 3. The camera checks 306 for presence of advanced-processing intermediate results in nonvolatile memory 120. If 307 intermediate results are found in nonvolatile memory 120, their accompanying image identifying information is read from nonvolatile memory 120 and used to locate 308 any associated initial compressed image in removable nonvolatile memory 108. If 310 the associated initial compressed image is found, the embedded image processing system 104 resumes 312 advanced processing of the images.

Once advanced processing is resumed 312, battery 112 charge and external power connection 124 status are periodically monitored 314 as previously discussed with reference to FIG. 2. Should battery 112 charge drop below the minimum level, or, if reserve is enabled and the battery charge drops below the reserve level, while external power is not connected, then intermediate results are saved 316 and advanced processing is suspended again.

When advanced processing 312 finishes 318, the advanced processing results are saved on removable nonvolatile memory 108 and the intermediate results are deleted.

If 310 no initial compressed image corresponding to the intermediate results were found, it is assumed that removable nonvolatile memory 108 has been changed. The intermediate results corresponding to that image are retained 320 until the space they occupy is needed for new intermediate results, such that advanced processing can resume if the original removable nonvolatile memory 108 is reinserted.

If 307 no intermediate results were found, if 310 no corresponding initial compressed image was found, or advanced processing of an image finished 318, image processing system 104 examines 322 removable nonvolatile memory 108 for images flagged for advanced processing. Should any such images be found, advanced processing is begun 324.

In an alternative embodiment, intermediate results are saved to removable nonvolatile memory 108 instead of to internal nonvolatile memory 120. With this embodiment, intermediate results are saved in an intermediate results subdirectory of a directory of a filesystem on removable nonvolatile memory 108 in which initially compressed and fully advanced processed images are stored. In an alternative embodiment, the intermediate results subdirectory is a hidden directory.

The removable media 108 may be removed at any time by a user despite warnings hereinafter disclosed.

A sequence similar to that discussed with reference to restarting advanced processing upon connection of a battery is invoked upon the camera's detecting 326 reinsertion of the removable nonvolatile memory 108. When nonvolatile memory 108 is reinserted 326, any ongoing advanced processing is suspended 328, and intermediate results are saved in nonvolatile memory as heretofore discussed. Then, the camera 100 checks for 306 any partially-processed or intermediate images previously written in nonvolatile memory and, if 307 any are found, the camera locates 308 any corresponding initially compressed image in the removable nonvolatile memory 108. If 310 intermediate results having corresponding initially compressed images are found, advanced processing of those images is resumed 312. Similarly, the camera can resume advanced processing of an image for which advanced processing was suspended upon a ‘Shutter’ button press after completion of initial compression of the new image.

Some advanced processing algorithms, such as blur correction, may require more data than saved 208 in the initial compressed 206 image. These algorithms may require raw or additional data such as data captured 202 with the original image. When these advanced processing algorithms are used, the necessary raw image data is saved 240 and treated as described herein as part of intermediate results.

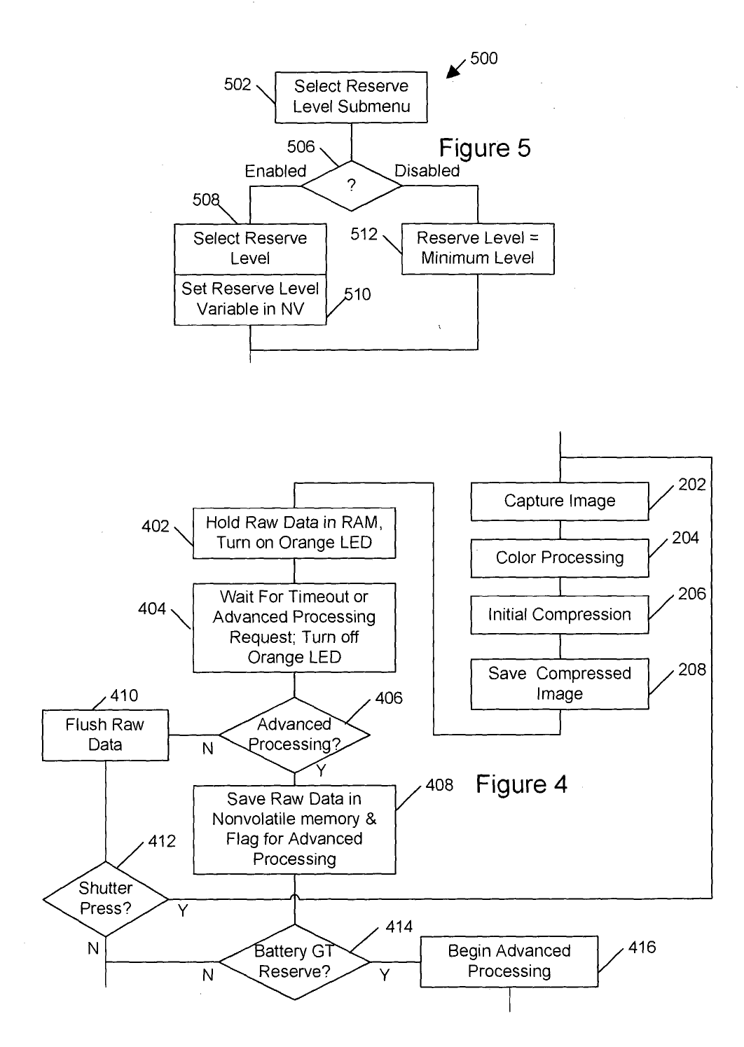

In an alternative embodiment, illustrated in FIG. 4 in conjunction with FIG. 2, advanced processing is conditioned upon user approval of an initial image. In this embodiment, the image is captured 202, color is processed 204, the image is initially compressed 206, and saved 208 as heretofore described. The captured image is displayed on display 109. Any raw or additional data required for advanced processing is retained 402 in RAM memory 106 for a few seconds while the camera waits 404 for a timeout, a ‘Shutter’ button press, or a ‘Mode’ button press to indicate that advanced processing of the captured image is desired. If 406 advanced processing is indicated for the image, the raw or additional data is saved 408 as heretofore described, the image is marked as requiring advanced processing, and if 414 the battery charge remains above the reserve level, advanced processing is begun 416. If 406 advanced processing were not indicated for the image, the raw or additional data is flushed 410 from RAM 106. If 412 the ‘Shutter’ button of buttons 118 were pressed, the camera captures 202 a replacement image as instructed. If the timeout occurs, the raw, or additional, data is flushed and the display 109 is turned off to conserve power. It is expected that performing advanced processing only on user-approved images will conserve battery charge.

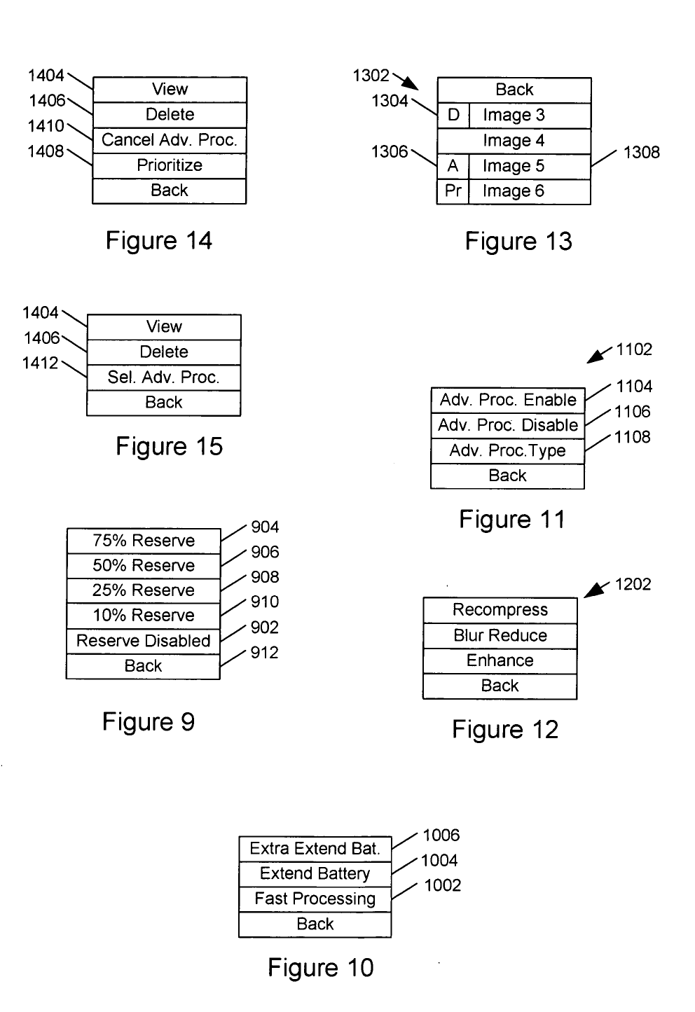

The present camera has a menu system, implemented in firmware operating on management processor 110, using display 109 and buttons 118. FIG. 5 illustrates operation 500 of an exemplary submenu in this menu system, the menu as displayed is illustrated in FIG. 9. This submenu is activated through selection 502 via a ‘Menu’ button of the reserve-level submenu from a higher-level menu. Once the submenu is activated, a list of reserve level choices (FIG. 9), including a Disable 902 reserve level option, is displayed. The list has a highlighted entry, indicating the current state of reserve-level disable flag and reserve-level register. The ‘Up’ 150 and ‘Down’ 152 buttons move the highlighted entry to an entry of a user's choice on display 109. The ‘Menu ’ button 156 of buttons 118 activates the selected reserve-level flag and reserve level option in management nonvolatile memory 116. If 506 the ‘Menu’ button of buttons 118 is pressed while the highlighted entry specifies a reserve level other than ‘Disabled’, the reserve-level flag is enabled and the appropriate reserve level is set 508. The reserve level variable is set 510 to the desired level. If 506 the ‘Menu’ button is pressed while the highlighted option is ‘Disabled’, the reserve level flag is disabled, and the reserve level variable in management nonvolatile memory 116 is set 512 to equal the minimum battery level. In a particular embodiment, the reserve level options include seventy-five percent 904, fifty percent 906, twenty-five percent 908, ten percent 910, as well as ‘Disabled’ 902. ‘Back’ option 912 indicates no change will be made to preexisting reserve-level flag and reserve level variable contents.

A similar menu as illustrated in FIG. 10 is used to set a clock rate variable in management nonvolatile memory 116 for use in the adjust clock rate step 236 previously discussed with reference to FIG. 2. The menu includes a ‘Fast Processing’ 1002 option, if this is selected the clock rate is not reduced for advanced processing. The menu includes an ‘Extend Battery’ life option, which selects an intermediate clock rate to conserve battery power. The menu also includes an ‘Extra Extend Battery’ life option, which selects a slow clock rate for advanced processing.

While advanced processing is in process, 314, 218, or 230, the camera remains responsive to any pressing of the ‘Shutter’ button of buttons 118. Should the ‘Shutter’ button be pressed, the camera saves the present state of advanced processing as intermediate results in nonvolatile memory 120. In the alternative embodiment where intermediate results are saved on removable nonvolatile memory 108, new intermediate results are saved in removable nonvolatile memory 108. The camera then captures 202 a new image.

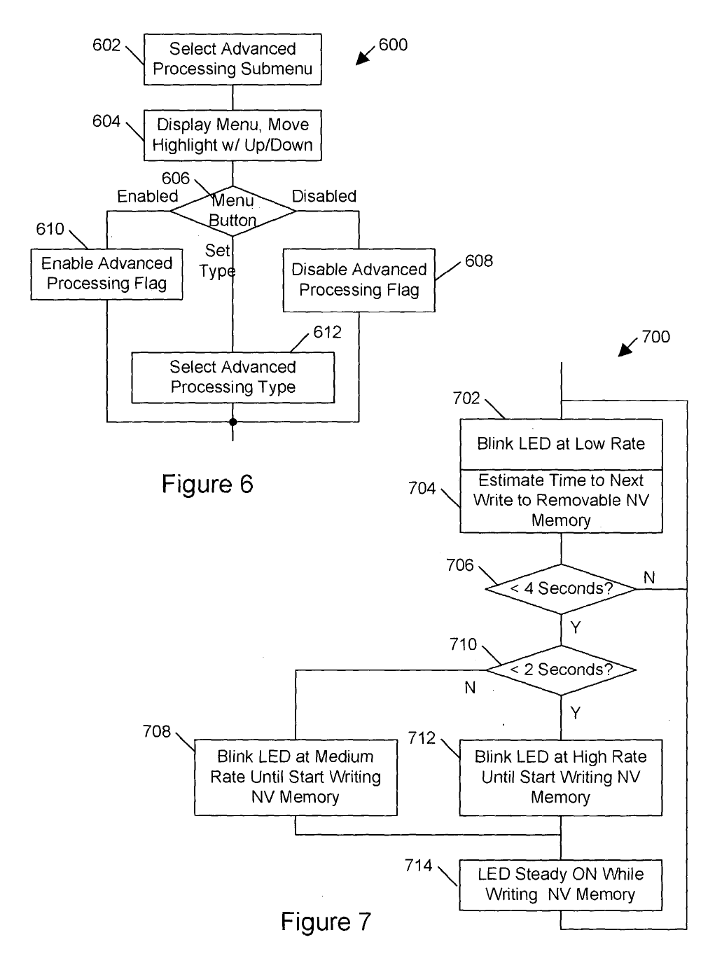

Another submenu, as illustrated in FIG. 11 and operating according to the flowchart 600 of FIG. 6, is used to enable or disable advanced processing and to select appropriate advanced processing algorithms. This menu is activated 602 through the ‘Menu’ button while a higher-level menu is displayed. When activated, the menu 1102 is displayed. Next, a current state of the advanced processing flag checked 210 above with reference to FIG. 2 is displayed by highlighting the advanced processing enable 1104 or advanced processing disable 1106 options. The ‘Up’ and ‘Down’ buttons then move the highlighted option to select an enable 1104, disable 1106, or set processing type 1108 option. Pressing the ‘Menu’ button 606 while the disable option 1106 is highlighted causes the advanced processing flag to be saved 608 in the disabled state. Pressing the ‘Menu’ button 606 while the enabled option 1104 is highlighted causes the advanced processing flag to be saved 610 in an enabled state. Pressing the ‘Menu’ button while the set type option 1108 causes entry to a selection menu 1202 such as illustrated in FIG. 12 whereby a user may select 612 a type of advanced processing desired from a list of advanced processing types supported by firmware of the image processing system 104. Selecting 612 a type of advanced processing is permitted when advanced processing is disabled; this selection is used with conditional advanced processing as discussed with reference to FIG. 4. In an alternative embodiment, the advanced processing type setting includes both a settable type of advanced processing and a settable format for saving the advanced-processed image; this permits operation of advanced processing such as local-contrast-enhancement with an uncompressed file type such as TIFF.

Advanced processing may require substantial time. It is possible than a user may desire to change the removable nonvolatile memory 108 at some point during this time. During advanced processing, the embedded image processing system 104 may have intermediate results or partially processed images, or finished processed images that may need to be saved on removable nonvolatile memory 108. In order to encourage the user to avoid changing removable nonvolatile memory 108 during a time that the embedded image processing system 104 is writing to it, the camera 100 is equipped with signal light emitting diodes (LEDs) 130. One of these signal LEDs 130 is an orange LED. When the camera 100 is performing advanced processing, the user is signaled to avoid changing removable nonvolatile memory 108 during writing via the method 700 illustrated in FIG. 7.

When the camera is performing advanced processing, the orange LED is normally blinked at a slow rate 702 such as once per second. The embedded image processing system 104 periodically estimates 704 time lag to the next write of the removable nonvolatile memory 108. If 706 estimated time lag is less than, for example, four seconds, the LED blink rate is increased to blink 708 at a medium rate, such as 2 ‘blinks’ per second. If 710 estimated time lag is less than approximately two seconds, the LED blink rate is increased to blink 712 at a high rate, for example, 4 ‘blinks’ per second. The LED is set to steady ON 714 during writing of the removable nonvolatile memory 108. The LED is therefore used by the camera to indicate to a user that the camera is prepared to write to, or in the process of writing to, the nonvolatile memory 108.

Other light emitting devices may also be used in alternative embodiments in place of the light-emitting diode heretofore discussed. For example, an incandescent bulb may be used in an alternative embodiment. In yet other embodiments, other visual indicators may be used such as a blinking icon on a liquid-crystal display.

The blinking LED also serves to remind a user to not remove batteries during a write to the nonvolatile memory, since this could cause corruption of saved data.

In an embodiment, intermediate results are saved to nonvolatile memory periodically as well as when low battery is detected. Should a user disrupt advanced processing by removing batteries while advanced processing is in progress, the saved data permits resumption of advanced processing upon replacement of the batteries or connection of external power.

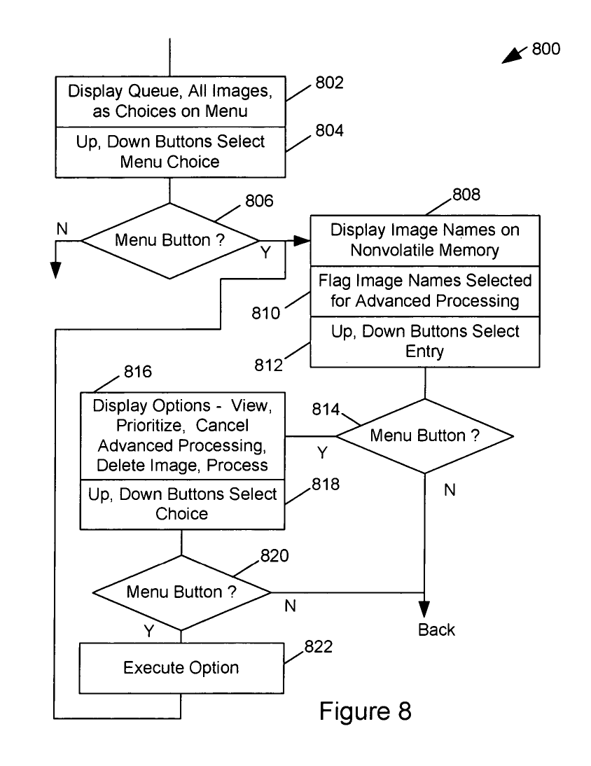

Another submenu is used to display a list of captured images with status of advanced processing, and to allow a user to add or delete images from this list. This submenu operates according to the flowchart 800 in FIG. 8. A first menu (not shown) is activated through pressing the ‘Menu’ button while a higher-level menu is displayed on the display 109. A list of choices is displayed 802, including an ‘All Images’ and a ‘Queued Images’ option. ‘Up’ 150 and ‘Down’ 152 buttons allow a user to select 804 particular options, a selected option is indicated by highlighting the option. When either the ‘All Images’ or ‘Queued Images’ option is selected, and the ‘Menu’ button is pressed 806, a list 1302 of image names of the appropriate types is displayed 808 as illustrated in FIG. 13. Each image that has had advanced processing completed is flagged with an icon, such as a ‘D’ 1304. Those images that have been selected for advanced processing, but for which processing is not yet complete, are flagged 810 with an advanced-processing requested icon, such as an ‘A’ 1306. The ‘Up’ 150 and ‘Down’ 152 buttons allow a user to select 812 an image name, such as image name 1308; if an image name is selected and the ‘Menu’ button is pressed again 814, a list of options is displayed 816 as illustrated in FIGS. 14 and 15.

Among the options displayed 816 are ‘View’ 1404 and ‘Delete’ 1406 options, if the image has been selected for advanced processing, ‘Prioritize’ 1408 and ‘Cancel Advanced Processing’ 1410 options are displayed as shown in FIG. 14. The View option allows a user to view the selected image on the display 109. The ‘Delete’ 1406 option allows the user to delete the image and cancel advanced processing, thereby reclaiming space in nonvolatile memory 108. The ‘Prioritize’ option 1408 allows the user to reposition the image in a queue of images for advanced processing, such that it will be the next image to be processed. The ‘Cancel Advanced Processing’ 1410 option allows the user to cancel advanced processing of the selected image.

If the image has not been selected for advanced processing, and sufficient data remains within the camera to permit advanced processing of the selected image, a select ‘Advanced Processing’ option 1412 is included in the list of options as shown in FIG. 15.

Again, the ‘Up’ 150 and ‘Down’ 152 buttons are used to select one of the above-described options. Pressing the ‘Menu’ button 820 again causes the selected option to be executed 822, whereupon the list of image names is again displayed 808.

An embodiment of the camera 100 also allows the user to trigger the camera to save intermediate results on the removable nonvolatile memory 108 to permit later resumption of advanced processing. This is accomplished through the user's pressing the ‘Menu’ button while the camera is performing advanced processing.

While monitoring of battery charge has been discussed with reference to periodic examination of battery status and with suspension of advanced processing occurring upon low battery conditions, it is anticipated that, in an alternative embodiment, battery status is monitored continuously. In this embodiment, low battery is detected battery monitor 113. Upon detection of low battery, a ‘low-battery’ interrupt is generated to the image processing system. Upon receiving the ‘low-battery’ interrupt, the image processing system ensures that all information necessary to restart advanced processing, including intermediate results is saved in nonvolatile memory 108 or 120. Once this information is saved, the embedded image processing system is shut down to conserve remaining battery charge.

The foregoing has referenced specific LED colors. It is anticipated that LED colors may be freely interchanged, and other colors substituted, while remaining within the spirit of the disclosure and claims that follow. It is also expected that other forms of warning signals, including audio signals may be substituted for the LED specified.

It is anticipated that an icon on a liquid-crystal display may also be used to indicate when nonvolatile memory is about to be written and a user should not remove removable nonvolatile memory from the camera. The term visual indication in this document includes an LED as well as such an icon.

While the foregoing has been particularly shown and described with reference to particular embodiments thereof, it will be understood by those skilled in the art that various other changes in the form and details may be made without departing from the spirit hereof. It is to be understood that various changes may be made in adapting the description to different embodiments without departing from the broader concepts disclosed herein and comprehended by the claims that follow:

1-14. (Cancelled).

15. A digital camera comprising:
an image sensor;
an image processing subsystem, coupled to the image sensor to receive images therefrom, having firmware to perform at least one form of advanced image processing on captured images to generate advanced-processed images therefrom; and
a first nonvolatile memory of a type selected from the group consisting of EEPROM and ferroelectric memory;
wherein the image processing system is coupled to the first nonvolatile memory and includes firmware for saving intermediate results produced during said advanced processing in the first nonvolatile memory, for suspending said advanced image processing on low battery, and for resuming said advanced processing using the intermediate results stored in the first nonvolatile memory; and
wherein the at least one form of advanced image processing is selected from the group consisting of recompression with a space-efficient compression algorithm, post-capture blur correction, local contrast enhancement, automatic photomosaic creation, and blending over and under exposed images.

16. The camera of claim 15, wherein the intermediate results are saved in the first nonvolatile memory-upon detection of a low battery charge.

17. The camera of claim 15, wherein the first nonvolatile memory is a nonremovable nonvolatile memory, and the camera further comprises removable nonvolatile memory for storing said advanced-processed images.

18. The camera of claim 17, wherein the intermediate results are saved in the nonvolatile memory periodically during said advanced processing of each of the images.

19. The camera of claim 18, wherein the intermediate results are saved in the nonvolatile memory-upon detection of a low battery charge.

20. The camera of claim 15, wherein the first nonvolatile memory in which the intermediate results associated with said advanced processing are stored is a removable nonvolatile memory, and wherein the camera has firmware for storing advanced-processed images in the first nonvolatile memory; and wherein a battery charge level for detection of low battery during advanced processing is a higher battery charge level than a battery charge level at which image capture functions are disabled on low battery.

21. The camera of claim 15, wherein the at least one form of advanced image processing is selected from the group consisting of post-capture blur correction, local contrast enhancement, automatic photomosaic creation, and blending over and under exposed images.

22. The camera of claim 21, wherein the at least one form of advanced image processing is selected from the group consisting of automatic photomosaic creation, and blending over and under exposed images.

23. The camera of claim 22, wherein the first nonvolatile memory in which the intermediate results associated with said advanced processing are stored is a removable nonvolatile memory, and wherein the camera has firmware for storing advanced-processed images in the first nonvolatile memory; and wherein a battery charge level for detection of low battery during advanced processing is a higher battery charge level than a battery charge level at which image capture functions are disabled on low battery.

24. The camera of claim 21, wherein sufficient information is available in the intermediate results saved in nonvolatile memory to resume blur reduction processing on previously captured images when sufficient battery charge is available.
